(19) United States
(12) Patent Application Publication
(10) Pub. No.: US 2015/0197917 A1
(43) Pub. Date: Jul. 16, 2015

(54) PIERCING TIP FOR A SHEAR

(71) Applicant: Caterpillar Inc., Peoria, IL (US)

(72) Inventor: John Kevin Clemons, Wamego, KS (US)

(73) Assignee: Caterpillar Inc., Peoria, IL (US)

(21) Appl. No.: 14/155,817

(22) Filed: Jan. 15, 2014

(51) Int. Cl. E02F 3/96; B23D 35/00

(52) U.S. Cl. CPC E02F 3/965; B23D 35/001; B23D 35/002

(57) ABSTRACT

A piercing tip for a shear is disclosed. The piercing tip may have a first part configured to be secured to a jaw of the shear. The first part may have a first planar surface configured to abut a first side surface of the jaw. The piercing tip may also have a second part configured to be secured to the jaw and the first part. The second part may have a planar portion including an inner surface configured to abut a second side surface of the jaw. The second part may also have a projecting portion including an upper surface configured to abut a lower surface of the jaw, and a projecting surface abutting the first planar surface of the first part.

### TECHNICAL FIELD

The present disclosure is directed to a piercing tip and, more particularly, to a piercing tip for a shear.

### BACKGROUND

A conventional heavy-duty shear typically employs upper and lower jaws with shear blades of hardened steel on both the upper jaw and the lower jaw. The distal end of a movable jaw member is provided with a replaceable piercing tip by which a workpiece is pierced and severed during closure of the jaw members relative to one another.

A suitable piercing tip is configured with sufficient strength to withstand the high forces required to shear an object. In addition, repeated use subjects the piercing tip to extreme wear and accordingly may require frequent replacement. Therefore, features that extend the life of a piercing tip and minimize down time are also desirable.

An example of a replaceable piercing tip is described in U.S. Pat. No. 6,839,969 which issued to Jacobson et al. on Jan. 11, 2005 (“the '969 patent”). The piercing tip of the '969 patent includes two L-shaped sections that contact each other underneath a jaw. The piercing tip is positioned and held in place only by a plurality of cap-screws that pass through the jaw. These and other features of the piercing tip of the '969 patent may be less than ideal.

The present disclosure is directed to overcoming one or more of the problems set forth above and/or other problems of the prior art.

### SUMMARY

In one aspect, the present disclosure is directed to a piercing tip for a shear. The piercing tip may include a first part configured to be secured to a jaw of the shear. The first part may include a first planar surface configured to abut a first side surface of the jaw. The piercing tip may also include a second part configured to be secured to the jaw and the first part. The second part may include a planar portion including an inner surface configured to abut a second side surface of the jaw. The second part may also include a projecting portion including an upper surface configured to abut a lower surface of the jaw, and a projecting surface abutting the first planar surface of the first part.

In another aspect, the present disclosure is directed to a piercing tip for a shear. The piercing tip may include a planar first part configured to be secured to a jaw of the shear. The first part may include a first planar surface, and a second planar surface configured to abut a first side surface of the jaw. The first part may also include a first pair of seat surfaces formed between the first and second planar surfaces, and a second pair of seat surfaces formed between the first and second planar surfaces. The second pair of seat surfaces may be symmetrically arranged with respect to the first pair of seat surfaces. The piercing tip may also include a second part configured to abut a second side surface and a lower surface of the jaw, and abutting the second planar surface of the planar first part. The first part may be reversible between a first orientation in which the first pair of seat surfaces are exposed for use as a cutting edge and the second pair of seat surfaces abut seat surfaces of the jaw, and a second orientation in which the second pair of seat surfaces are exposed for use as a cutting edge and the first pair of seat surfaces abut the seat surfaces of the jaw

### BRIEF DESCRIPTION OF THE DRAWING

FIG. 1 illustrates an exemplary disclosed shear;

FIGS. 2-3 illustrate an upper jaw of the shear of FIG. 1, equipped with an exemplary disclosed piercing tip, according to a first embodiment;

FIG. 4-5 illustrate an exploded view of the piercing tip of FIGS. 2-3;

FIG. 6 illustrates an upper jaw of a shear, equipped with an alternative exemplary disclosed piercing tip;

FIG. 7 illustrates an exemplary disclosed part of the piercing tip of FIG. 6;

FIGS. 8-9 illustrate an upper jaw of the shear of FIG. 1, equipped with an exemplary disclosed piercing tip, according to a second embodiment; and

FIGS. 10-11 illustrate the upper, aw and an exploded view of the piercing tip of FIGS. 8-9.

### DETAILED DESCRIPTION

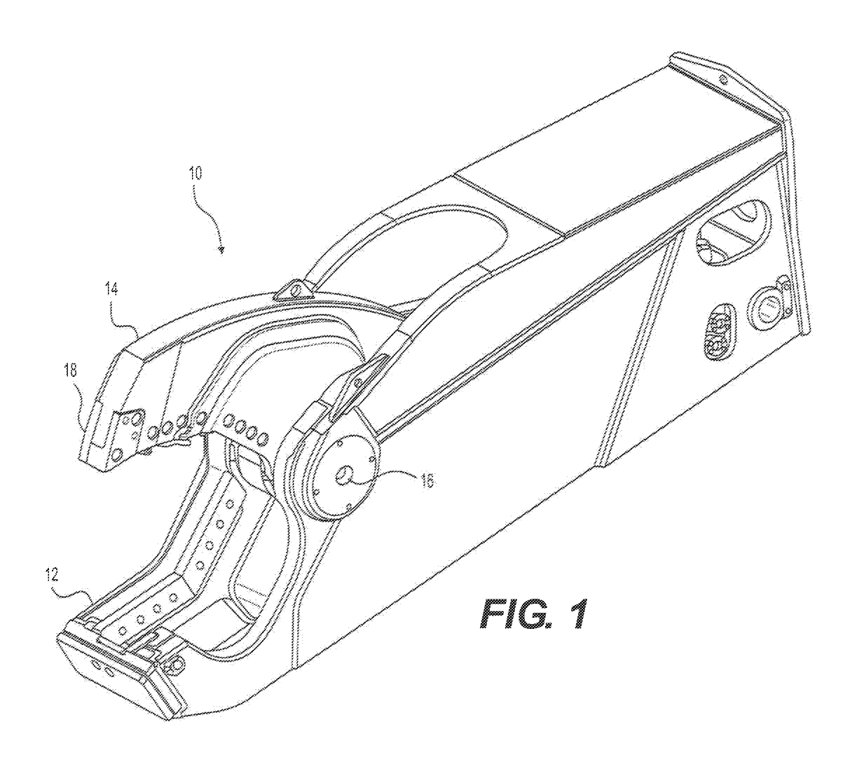

FIG. 1 illustrates an exemplary shear 10. In an exemplary embodiment, shear 10 may be a hydraulic shear, although other types of shears are possible. In some embodiments, shear 10 may be a heavy-duty shear, such as a metal demolition shear or a scrap shear. In some embodiments, shear 10 may be attached to the boom structure of, for example, excavating or earth-moving excavation equipment. Shear 10 may include a fixed or stationary lower jaw 12, a movable upper jaw 14, and a pivot structure 16 movably connecting lower jaw 12 and upper jaw 14. Hydraulic components (not shown) may be operated to move upper jaw 14 via pivot structure 16 to close upper jaw 14 with respect to lower jaw 12.

Upper jaw 14 may include a replaceable piercing tip 18. Piercing tip 18 may be arranged to cover a lower piercing portion of upper jaw 14. Piercing tip 18 may protect upper jaw 14 and form cutting edges and contact surfaces that cooperates with a cutting edge of lower jaw 12 for piercing and cutting an object (e.g., a metal beam) placed between the jaws. Piercing tip 18 may be formed of a material sufficient to withstand high piercing and cutting forces, such as a hard metal (e.g., hardened steel).

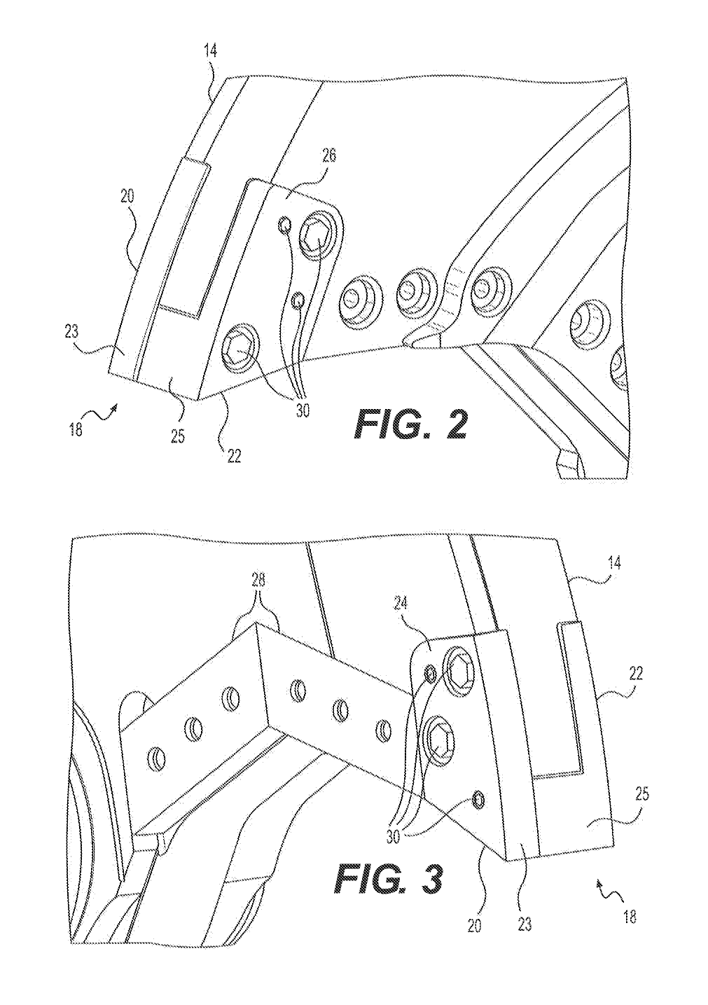

FIGS. 2-3 depict an exemplary upper jaw 14 equipped with a piercing tip 18, according to a first exemplary disclosed embodiment. Piercing tip 18 may be a two-part structure including a first part 20 and a second part 22. First part 20 and second part 22 may be secured to upper jaw 14 and at least partially cover a lower piercing portion of jaw 14. First part 20 may include a pair of outer surfaces 23, 24, and second part 22 may include a pair of outer surfaces 25, 26.

As shown in FIGS. 2-3, first part 20 and second part 22 may be sized and arranged to fit within cutout regions formed by upper jaw 14, such that outer surfaces 23, 24, 25, 26 are positioned to be continuous with outer surfaces of upper jaw 14. In this way, when attached to upper jaw 14, piercing tip 18 may be flush with uncovered outer surfaces of upper jaw 14, allowing piercing tip 18 and upper, aw 14 to be received by a corresponding lower jaw (e.g., lower jaw 12 shown in FIG. 1) during operation of shear 10.

The extent of outer surfaces 23, 24, 25, 26 may define an outer cutting edge of piercing tip 18. As shown in FIG. 3, upper jaw 14 may also include one or more collar members 28 that define an additional cutting edge that extends along an arm portion of upper jaw 14. In an exemplary embodiment, a plurality of bolts 30 may secure first part 20 and second part 22 to each other and upper jaw 14. However, it should be understood that other fastening means are possible.

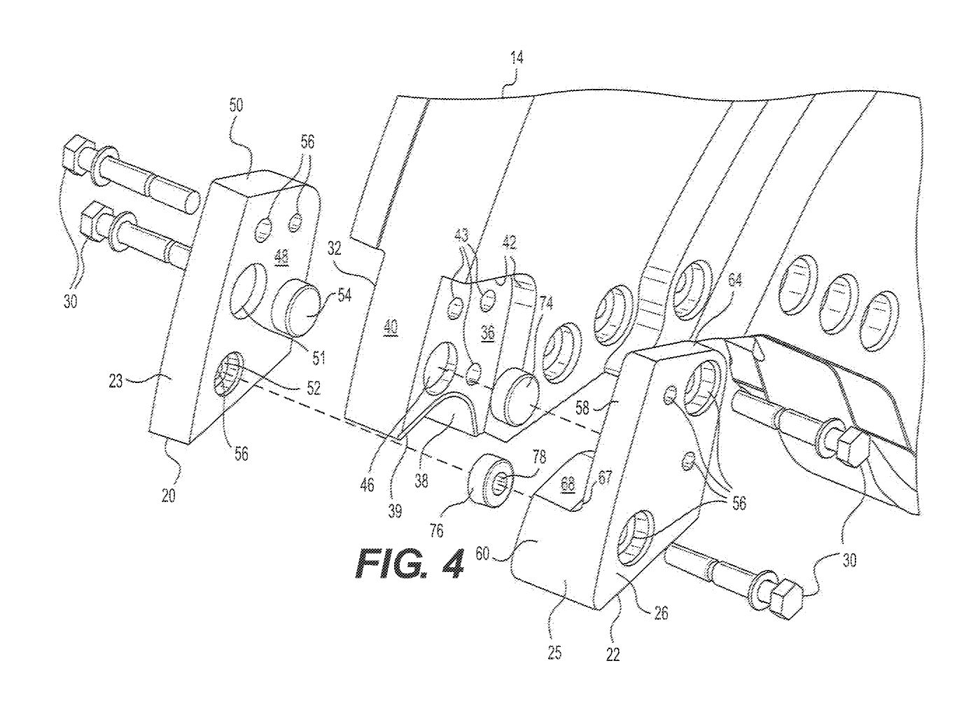

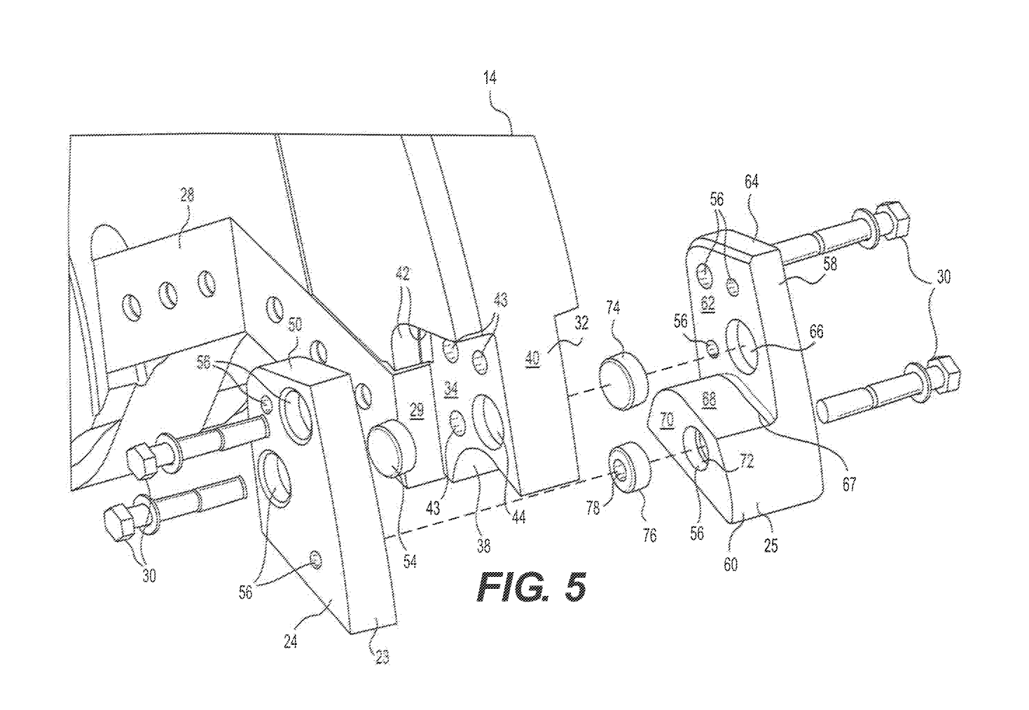

FIGS. 4-5 further depict upper jaw 14 and the components of piercing tip 18. In an exemplary embodiment, first part 20 and second part 22 may be arranged to cover a lower piercing portion 32 of upper jaw 14. In the embodiment depicted in FIGS. 4-5, upper jaw 14 includes a plurality of surfaces that define lower piercing portion 32 and the cutout regions that are configured to receive first part 20 and second part 22. In an exemplary embodiment, upper jaw 14 includes a first side surface 34 (shown only in FIG. 5), a second side surface 36 (shown only in FIG. 4), a lower surface 38, a front surface 40, and a plurality of seat surfaces 42. A plurality of through-holes 43 may extend through upper jaw 14, from first side surface 34 to second side surface 36. In addition, first side surface 34 may include a cavity 44 (shown only in FIG. 5) and second side surface 36 may include a cavity 46 (only shown in FIG. 4).

As shown in FIGS. 4-5, first part 20 be a planar component, defined by outer surfaces 23 and 24, an inner surface 48, a seat surface 50, and a bottom surface (not shown) that defines a portion of the cutting edge of piercing tip 18. Outer surface 24 and inner surface 48 may be generally planar surfaces with outer surface 23, seat surfaces 50, and the bottom surface defined therebetween. Inner surface 48 may be arranged to face upper jaw 14. First part 20 may include cavities 51 and 52 formed in inner surface 48.

In exemplary embodiment, first part 22 may be secured to upper jaw 14 to cover one side of lower piercing portion 32. In securing first part 20 to upper jaw 14, first part 20 may be configured to fit in a first cutout region formed by upper jaw 14 such that inner surface 48 abuts first side surface 34 and seat surface 50 abuts adjacent seat surfaces 42. In certain embodiments, seat surface 50 may also abut a surface 29 of collar member 28. A dowel 54 may be positioned in cavities 44 and 51 to align first part 20 with upper jaw 14.

First part 20 may also include attachment holes 56 configured to receive a portion of a bolt 30. Some attachment holes 56 may be through-holes extension from outer surface 24 to inner surface 48 and configured to receive an upper end of a bolt 30. The through-holes may include corresponding cavities in outer surface 24 that are configured to receive a head portion of a bolt 30. Other attachment holes 56 may be threaded holes configured to receive a threaded lower end of a bolt 30.

As shown in FIGS. 4-5, second part 22 may be a component that includes portions extension in at least two directions, including a planar portion 58 and a projecting portion 60. Second part 22 may include a bottom surface (not shown) defined by planar portion 58 and projecting portion 60, the bottom surface defining a portion of the cutting edge of piercing tip 18. Planar portion 58 may include an inner surface 62 and a seat surface 64. In an exemplary embodiment, planar portion 58 may be a generally planar component defined by inner surface 62 and outer surface 26, including a thickness defined by seat surface 64 and portions of outer surface 25 and the bottom surface (and any edge surfaces therebetween). Planar portion 58 may include a cavity 66 formed in inner surface 62.

In an exemplary embodiment, projecting portion 60 may extend from planar portion 58 towards first part 20 (e.g., when connected to upper jaw 14). Projecting portion 60 may include an upper surface 68 and a projecting surface 70, together defining projecting portion 60 with portions of outer surface 25 and the bottom surface. Upper surface 68 may be sized and shaped to correspond to lower surface 38 of upper jaw 14. For example, upper surface 68 may be curved to match a curved lower surface 38. A cavity 72 may be formed in projecting surface 70. In some embodiments, a radiused corner 67 may be formed between inner surface 62 and upper surface 68 of projecting portion 60 of second part 22. Radiused corner 67 may correspond to a chamfered corner 39 of upper jaw 14 (as shown in FIG. 4), allowing for clearance at the interface of second part 22 and upper jaw 14 at radiused corner 67.

In an exemplary embodiment, second part 22 may be secured to upper jaw 14 to cover at least two sides of lower piercing portion 32. In securing second part 22 to upper jaw 14 and first part 20, second part 22 may be configured to fit in a second cutout region formed by upper jaw 14 such that inner surface 62 abuts second side surface 36, seat surface 64 abuts seat surface 42, upper surface 68 abuts lower surface 38, and projecting surface 70 abuts a portion of inner surface 48 of first part 22. In an exemplary embodiment, upper surface 68 may be sized and shaped to cover the entire lower surface 38. A dowel 74 may be positioned in cavities 46 and 66 to align second part 22 with upper jaw 14. Similarly, a dowel 76 may be positioned in cavities 52 and 72 to align first part 20 with second part 22.

Second part 22 may also include attachment holes 56, each configured to receive a portion of a bolt 30. As with first part 20, some attachment holes 56 of second part 22 may include through-holes extension from outer surface 26 to inner surface 62 and configured to receive an upper end of a bolt 30. The through-holes may include corresponding cavities in outer surface 24 that are configured to receive a head portion of a bolt 30. Other attachment holes 56 may be threaded holes configured to receive a threaded lower end of a bolt 30.

In an exemplary embodiment, bolts 30 may extend through attachment holes 56 and through-holes 43 of upper jaw 14 to secure first part 20 and second part 22 to each other and upper jaw 14. As shown in FIGS. 4-5, a through-hole in one of first part 20 or second part 22 may be aligned with a threaded hole in the other of first part 20 or second part 22 to receive upper and lower ends of a bolt 30, respectively. In addition, a bolt 30 may extend through attachment holes 56 corresponding to cavities 52 and 72, as well as a through-hole 78 in dowel 76, to secure first part 20 directly to second part 22 (e.g., with inner surface 48 in contact with projecting surface 70) and thereby further secure piercing tip 18 to upper jaw 14. In particular, a bolt 30 may pass through a through-hole formed in projecting portion 60 of second part 22, through-hole 78 of dowel 76, and be secured in a threaded hole formed in first part 20.

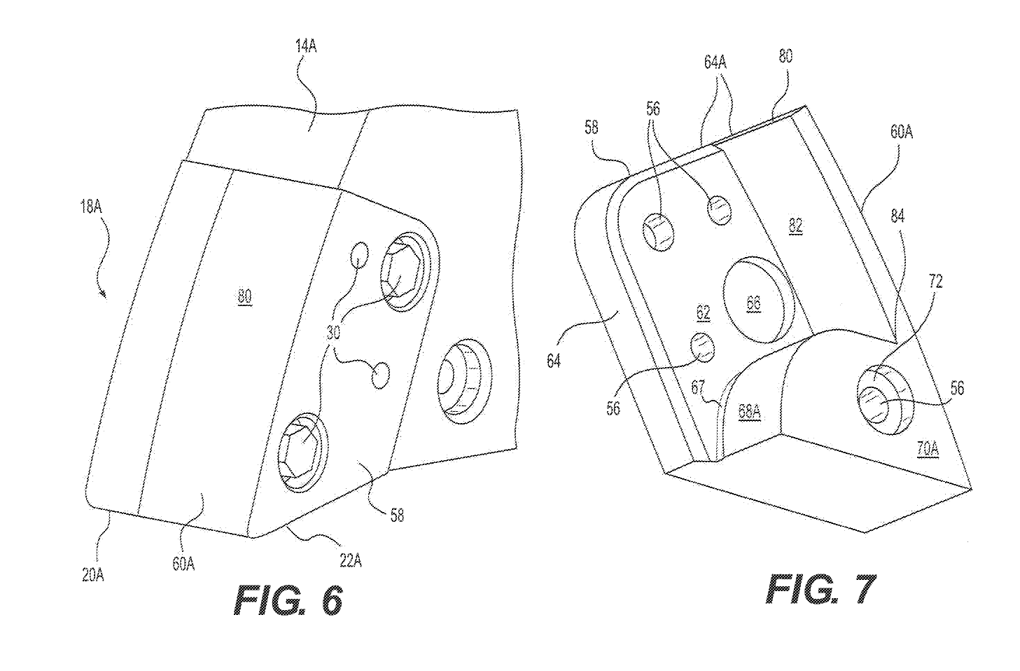

FIG. 6 depicts an upper jaw 14A equipped with a piercing tip 18A, according to an alternative embodiment. Upper jaw 14A may be identical to upper jaw 14 depicted in FIGS. 1-5, including lower piercing portion 32, except for an additional seat surface 42 located in front of a lower piercing portion of upper jaw 14A (not shown). Piercing tip 18A may include a first part 20A and a second part 22A. In an exemplary embodiment, first part 20A may be identical to first part 20. Second part 22A may be similar to second part 22, including an identical planar portion 58. However, second part 22A may include a projecting portion 60A, which may be the same as projecting portion 60, except for the inclusion of an extension portion 80. Extension portion 80 may be configured to cover a front surface portion of upper jaw 14A.

FIG. 7 depicts an exemplary embodiment of second part 22A, Planar portion 58 may include, for example, inner surface 62, seat surface 64, attachment holes 56, cavity 66, and radiused corner 67, as described above with respect to FIGS. 4-5. Projecting portion 60A may include upper surface 68A, projecting surface 70A, and inner surface 82. An attachment hole 56 and cavity 72 may be formed in projecting portion 60A for receiving dowel 76 and a bolt 30, in the manner as described above. In some embodiments, a radiused corner may be formed between inner surface 62 and upper surface 68A, such as to match a corresponding radiused corner of upper jaw 14A. Extension portion 80 may form an inside corner 84 between upper surface 68A and inner surface 82. Inside corner 84 may be configured to receive a leading edge (not shown) of upper jaw 14A. In addition, inner surface 82 may be perpendicular to inner surface 62, forming an L-shaped upper seat surface 64A.

In securing piercing tip 18A to upper jaw 14A, first part 20A and second part 22A may be positioned to abut a lower piercing portion of upper jaw 14A in the same manner that first part 20 and second part 22 abut upper jaw 14, as described above. In addition, inner surface 82 may abut and cover a front surface of upper jaw 14A. In this way, second part 221 be secured to upper jaw 14A to cover at least three sides of lower piercing portion 32. Upper seat surface 64A may abut a seat surface 42 of upper jaw 14A, including a seat surface 42 that extends around a front of upper jaw 14A. In this way, upper seat surface 64A, together with a seat surface 50 of first part 20A (shown only in FIGS. 4-5), may abut seat surfaces 42 of upper jaw 14A on three sides of upper jaw 14A.

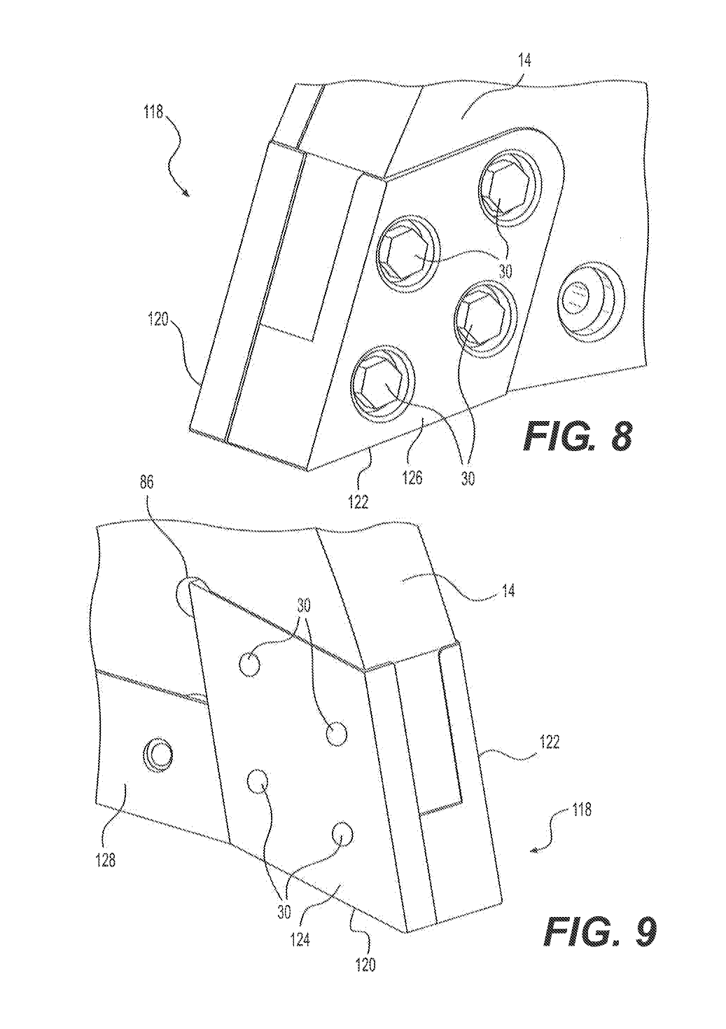

FIGS. 8-9 depict upper jaw 14 equipped with a piercing tip 118, according to a second exemplary disclosed embodiment. Piercing tip 118 may be a two-part structure, similar to that of piercing tip 18, including a planar first part 120 and a second part 122. First part 120 and second part 122 may be positioned in cutout regions on opposing sides of upper jaw 14 and secured by bolts 30. When attached to upper jaw 14, the outer surfaces of piercing tip 118 may be flush with uncovered outer surfaces of upper jaw 14 and a collar member 128, allowing piercing tip 118 and upper jaw 14 to be received by a corresponding lower jaw (e.g., lower jaw 12 shown in FIG. 1) during operation of shear 10.

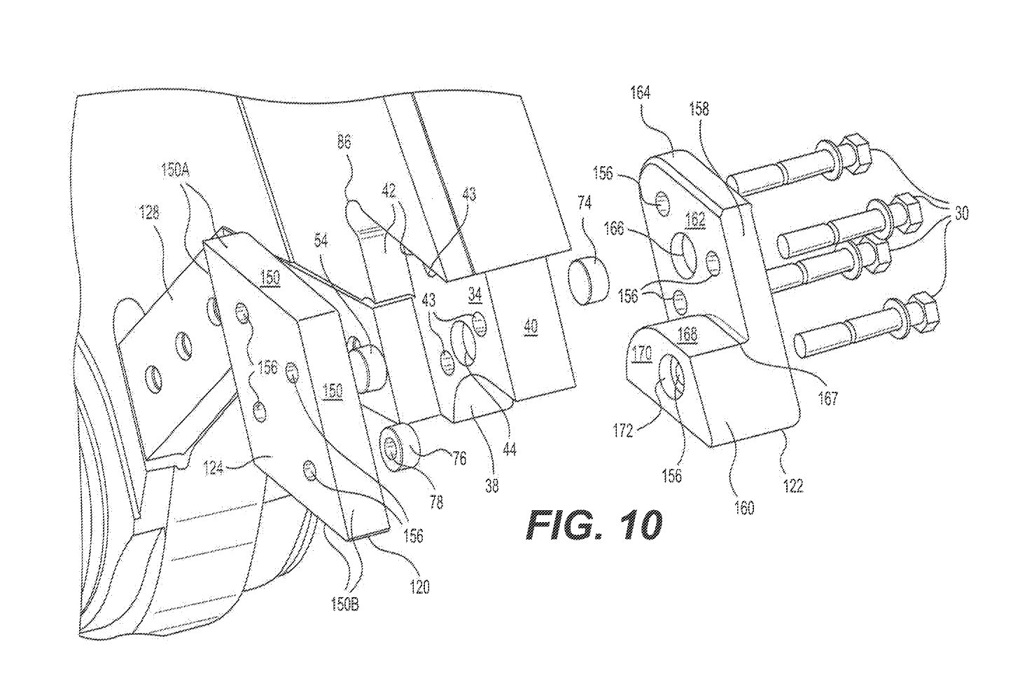

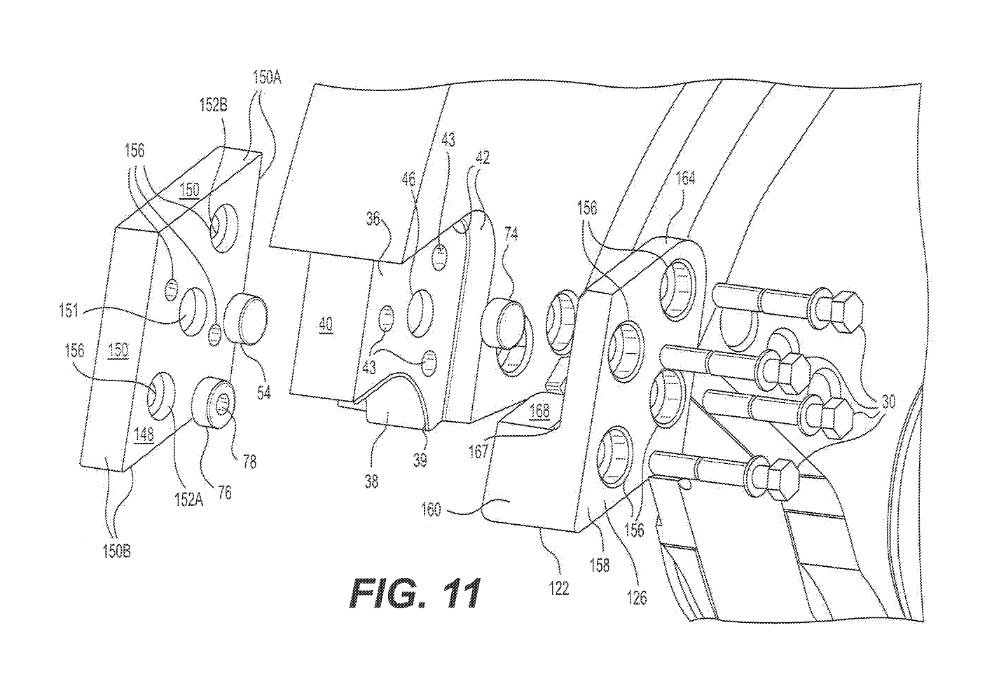

FIGS. 10-11 further depict upper jaw 14 and the components of piercing tip 118. As shown, upper jaw 14 includes a plurality of surfaces that define lower piercing portion 32 and the cutout regions that are configured to receive first part 120 and second part 122. In an exemplary embodiment, upper jaw 14 includes the same components and features that were described with respect to FIGS. 4-5. For example, a plurality of surfaces 34, 36, 38, 39, 40, 42 may define lower piercing portion 32 and cutout regions that correspond to the shapes of first and second parts 120 and 122. As shown in FIG. 10, upper jaw 14 may also include a relief portion 86 at a corner between a pair of seat surfaces 42.

In an exemplary disclosed embodiment, first part 120 may be similar to first part 20. For example, first part 120 may be a planar component, defined by an outer surface 124, an inner surface 148, and a plurality of seat surfaces 150. However, first part 120 may differ from first part 20 in that first part 120 is symmetrical. For example, as shown in FIGS. 10-11, first part 120 may be diamond-shaped, including two pairs of parallel sides defining symmetrical sides across an axis through opposite corners of first part 120. Seat surfaces 150 may include pairs of adjacent seat surfaces 150A and 150B, respectively associated with each symmetrical side of first part 120. Inner surface 148 may include attachment holes 156, which, in an exemplary embodiment, may each be threaded holes configured to receive a threaded end of a bolt 30. Inner surface 148 may also include cavities 151, 152A, and 152B. Cavities 151A and 152B may each surround an attachment hole 156 and be correspondingly positioned on opposing symmetric sides of inner surface 148.

Second part 122 may be similar to second part 22, including a planar portion 158 defined at least in part by an outer surface 126, an inner surface 162 and a seat surface 164, and a projecting portion 160 defined at least in part by an upper surface 168 and a projecting surface 170. Inner surface 162 and projecting surface 170 may include cavities 166 and 172, respectively. A radiused corner 167 may be formed between inner surface 162 and upper surface 168 of projecting portion 60 of second part 122. In an exemplary disclosed embodiment, second part 122 may differ from second part 22 only in attachment holes 156 formed between outer surface 126 and inner surface 162. For example, each attachment hole 156 in second part 122 may be a through-hole configured to receive an upper end of a bolt 30 (instead of some attachment holes 156 being threaded holes configured to receive a threaded lower end of a bolt 30, as with second part 22). However, it should be understood that attachment holes 156 may be arranged in other configuration (e.g., such that second part 122 is identical to second part 22). In some embodiments, second part 122 may include an extension portion (not shown) that is similar to extension portion 80 depicted in FIGS. 6-7.

First part 120 and second part 122 may be secured to upper jaw 14 and each other in a manner similar to that described above with respect to first part 20 and 22. In particular, first part 120 may be positioned in a first cutout region formed by upper jaw 14 such that inner surface 148 abuts first side surface 34 and some of seat surfaces 150 (e.g., seat surfaces 150A) abut corresponding seat surfaces 42. In some embodiments, a portion of a seat surface 150 may also abut surface 29 of collar member 28. A dowel 54 may be positioned in cavities 44 and 151 to align first part 120 with upper jaw 14.

In addition, second part 122 may be configured to fit in a second cutout region formed by upper jaw 14 such that inner surface 162 abuts second side surface 36, seat surface 164 abuts seat surface 42, upper surface 168 abuts lower surface 38, and projecting surface 170 abuts a portion of inner surface 148 of first part 120. Dowel 74 may be positioned in cavities 46 and 166 to align second part 122 with upper jaw 14. Similarly, dowel 76 may be positioned in cavities 152A and 172 to align first part 120 with second part 122.

In an exemplary disclosed embodiment, the symmetry of first part 120 allows it to be reversible. In other words, first part 120 may be configured to be secured in the corresponding cutout region of upper jaw 14 in more than one orientation. In a first orientation, first part 120 may be arranged such that seat surfaces 150A abut seat surfaces 42 of upper jaw 14, as described above. In this orientation, seat surfaces 150B are exposed for use as a cutting edge during operation of shear 10. In a second orientation, first part 120 may be rotated 180° and positioned such that seat surfaces 150B abut seat surfaces 42. In this orientation, seat surfaces 150A are exposed for use as a cutting edge during operation of shear 10. As described above, in the first orientation, dowel 76 may be positioned in cavity 152A, with cavity 152B unused (except for receipt of a portion of a bolt 30). In the second orientation, however, the positions may be reversed, and dowel 76 may be positioned in cavity 152B, with cavity 152A unused (except for a portion of a holt 30). In some embodiments, a washer or spacer (now shown) may be placed in the unused cavity 152A or 152B.

In an exemplary embodiment, bolts 30 may extend through attachment holes 156 and through-holes 43 of upper jaw 14 to secure first part 120 and second part 122 to each other and upper jaw 14. As shown in FIGS. 10-11, each through-hole in second part 122 may be aligned with a threaded hole in first part 120 to receive upper and lower ends of a bolt 30, respectively. In addition, a bolt 30 may extend through an attachment hole 156 corresponding to one of cavities 152A or 152B (depending on the orientation of first part 120), cavity 172, and through-hole 78 in dowel 76 to secure first part 120 directly to second part 122 (e.g., with inner surface 148 in contact with projecting surface 170) and thereby further secure piercing tip 118 to upper jaw 14. In particular, in the first orientation of first part 120, for example, a bolt 30 may pass through the through-hole formed in projecting portion 160 of second part 22, through-hole 78 of dowel 76, and be secured in a threaded hole corresponding to cavity 152A of first part 120.

### INDUSTRIAL APPLICABILITY

The exemplary disclosed piercing tips may be applicable to any shear that includes demolition shears and scrap shears. As disclosed herein, a piercing tip may be removably secured to an upper jaw of a shear to protect a lower piercing portion and provide sufficient strength to withstand forces associated with a shearing operation. In addition, various features of the exemplary disclosed piercing tips may provide for secure attachment, ease of replacement, and increased part life, among other advantages. Exemplary processes for attachment and use of the exemplary disclosed piercing tips will now be described.

In order to secure piercing tip 18 to upper jaw 14, first part 20 may be positioned in a corresponding cutout region formed by upper jaw 14. Dowel 54 may be positioned in cavities 44 and 51 such that first part 20 may be aligned with upper jaw 14 and moved into the correct position. Second part 22 may also be positioned in a corresponding cutout region formed on an opposing side of upper jaw 14. Dowel 74 may be positioned in cavities 46 and 66 such that second part 22 may be correctly aligned and positioned with respect upper jaw 14. Dowel 76 may be positioned in cavities 52 and 72 to ensure that first part 20 with is correctly aligned and positioned with respect to second part 22.

As shown in FIGS. 2-5, bolts 30 may be inserted through aligned attachment holes 56 and through-holes 43. An additional bolt may be inserted through aligned attachment holes 56 corresponding to cavities 52 and 72, and through-hole 78 of dowel 76, to further secure first part 20 and second part 22 to each other and upper jaw 14. The bolts may be torqued to secure a threaded lower end of each bolt 30 to a threaded hole in a corresponding one of first part 20 and second part 22. It should be understood that the order of the execution of these steps is not limited and may vary.

A process for positioning and securing an alternative piercing tip 18A may be substantially the same as the process for securing piercing tip 18. However, piercing tip 18A may be positioned such that extension portion 80 covers a front of lower piercing portion and abuts an additional seat surface 42 adjacent the front surface.

After the first part 20 and second part 22 are positioned and secured via bolts 30, piercing tip 18 may be ready to be used for shearing operations. For example, hydraulic controls may be operated to move upper jaw 14 in relation to lower jaw 12. Upper jaw 14 may pivot towards lower jaw 12 until piercing tip 18 enters lower jaw 12, shearing an object placed therebetween. In the process of shearing an object, pressure forces may be transferred from shearing tip 18 to upper jaw 14. In particular, forces on the cutting surfaces of piercing tip 18 may primarily be transferred to upper jaw 14 through the engaging contact of upper surface 68 with lower surface 38 and seat surfaces 50 and 64 with seat surfaces 42. Piercing tip 18 may be tightly secured to upper jaw 14 such that transfer of these forces is distributed across the surfaces.

Piercing tip 118 may be attached and used in the same manner as piercing tip 118. In addition, piercing tip 118 may be used in a process to reverse the orientation of first part 120. For example, piercing tip 118 may be secured to upper jaw 14 with seat surfaces 150A abutting seat surfaces 42 and seat surfaces 150B exposed. While in this position, piercing tip 118 may be repeatedly used in shearing operations, such as those described above. As a result, parts of piercing tip in contact with the objects being sheared (e.g., cutting edges adjacent seat surfaces 150B) may become worn. Subsequently, first part 120 may be removed from upper jaw 14, rotated 180°, and repositioned in a second orientation with seat surfaces 150B abutting seat surfaces 42 and seat surfaces 150A exposed, in this way, unworn edges may be exposed for shearing operations and the life of first part 120 may be extended.

The configuration of the exemplary disclosed piercing tips 18, 18A, and 118 for attachment and use in the exemplary processes described above may provide several advantages. For example, use of alignment dowels allows for ease of attachment, correct positioning, and tight securement of each part of the piercing tip to the upper jaw. Further, the configuration of a second part to extend and cover an entire lower surface of a lower piercing portion avoids contact of the two parts directly beneath the lower surface of the upper jaw, allowing transferred forces to be spread across a single, large surface. In addition, the positioning of a bolt through the projecting portion of the second part allows for direct connection of the two parts and improved securement of the piercing tip.

The alternative features and embodiments may also provide advantages over previous piercing tip designs. For example, use of an extension portion to cover the front portion of the upper jaw may further protect the upper jaw. In addition, the extension portion may allow for abutment of seat surfaces on a third (front) side of the upper jaw, further spreading out the transfer of forces from the piercing tip to the upper jaw. In an embodiment in which the first part of the piercing tip is reversible, aspects such as ease of attachment and part life may also be improved.

It will be apparent to those skilled in the art that various modifications and variations can be made to the piercing tip of the present disclosure without departing from the scope of the disclosure, Other embodiments will be apparent to those skilled in the art from consideration of the specification and practice of the embodiments disclosed herein. For example, additional embodiments may combine and incorporate features depicted in the various disclosed embodiments. It is intended that the specification and examples be considered as exemplary only, with a true scope of the disclosure being indicated by the following claims.

What is claimed is:

1. A piercing tip for a shear, comprising:
a first part configured to be secured to a jaw of the shear, the first part including a first planar surface configured to abut a first side surface of the jaw; and
a second part configured to be secured to the jaw and the first part, the second part including:
a planar portion including an inner surface configured to abut a second side surface of the jaw, and
a projecting portion including:
an upper surface configured to abut a lower surface of the jaw, and
a projecting surface abutting the first planar surface of the first part.

2. The piercing tip of claim 1, wherein the first part and the second part are secured to each other and configured to be secured to the jaw by a plurality of bolts.

3. The piercing tip of claim 2, wherein the first part and the second part are configured to receive at least one bolt that passes through a through-hole in one of the first part and the second part and a through-hole in the jaw, and is secured to a threaded hole in the other of the first part and the second part.

4. The piercing tip of claim 2, wherein at least one bolt passes through a through-hole in the projecting portion of the second part and is secured to a threaded hole in the first part.

5. The piercing tip of claim further including a plurality of dowels for aligning the piercing tip with the jaw, the plurality of dowels including:
a first dowel positioned in a cavity in the first planar surface of the first part and configured to be positioned in a cavity in the first side surface of the jaw; and
a second dowel positioned in a cavity in the inner surface of the second part and configured to be positioned a cavity in the second side surface of the jaw.

6. The piercing tip of claim 5, wherein the plurality of dowels further includes a third dowel positioned in a cavity in the first planar surface of the first part and a cavity in the projecting surface of the second part.

7. The piercing tip of claim 6, further including a bolt passing through a through-hole formed in the third dowel.

8. The piercing tip of claim 1, wherein the upper surface of the projecting portion is configured to cover the entire lower surface of the jaw.

9. The piercing tip of claim 1, wherein a corner is formed between the inner surface of the planar portion of the second part and the upper surface of the projecting portion of the second part, and the corner is radiused to match a radiused corner of the jaw.

10. The piercing tip of claim 1, wherein the projecting portion further includes a second inner surface configured to abut a front surface of the jaw.

11. The piercing tip of claim 10, wherein the second inner surface is perpendicular to the inner surface of the planar portion and forms an inside corner with the upper surface of the projecting portion, the inside corner configured to receive a leading edge of the jaw.

12. The piercing tip of claim 10, wherein:
the first part includes a first seat surface,
the second part includes an L-shaped second seat surface formed by the projecting portion and the planar portion, and
the first seat surface and second seat surface together are configured to abut seat surfaces of the jaw on three sides of the jaw.

13. A piercing tip for a shear, comprising:
a planar first part configured to be secured to a jaw of the shear, the first part including:
a first planar surface;
a second planar surface configured to abut a first side surface of the jaw;
a first pair of seat surfaces formed between the first and second planar surfaces; and
a second pair of seat surfaces formed between the first and second planar surfaces and symmetrically arranged with respect to the first pair of seat surfaces; and
a second part configured to abut a second side surface and a lower surface of the jaw, and abutting the second planar surface of the planar first part, wherein:
the first part is reversible between a first orientation in which the first pair of seat surfaces are exposed for use as a cutting edge and the second pair of seat surfaces abut seat surfaces of the jaw, and a second orientation in which the second pair of seat surfaces are exposed for use as a cutting edge and the first pair of seat surfaces abut the seat surfaces of the jaw.

14. The piercing tip of claim 13, further including a plurality of bolts configured to secure the planar first part and the second part to each other and the jaw.

15. The piercing tip of claim 14, wherein the first part and the second part are configured to receive at least one bolt that passes through a through-hole in one of the planar first part and the second part and a through-hole in the jaw and is secured to a threaded hole in the other of the planar first part and the second part.

16. The piercing tip of claim 13, further including a plurality of dowels for aligning the piercing tip with the jaw, the plurality of dowels including:
a first dowel positioned in a cavity in the planar first part and configured to be positioned in a cavity in the first side surface of the jaw; and
a second dowel positioned in a cavity in the second part and configured to be positioned in a cavity in the second side surface of the jaw.

17. The piercing tip of claim 16, wherein the plurality of dowels further includes a third dowel positioned in a cavity in the second part and a first cavity of the planar first part when the planar first part is in the first orientation and a second cavity of the planar first part when the planar first part is in the second orientation.

18. The piercing tip of claim 17, further including a bolt passing through a through-hole formed in the third dowel.

19. The piercing tip of claim 13, wherein a surface of the second part is configured to cover the entire lower surface of the jaw.

20. A shear comprising:
a lower jaw;
an upper jaw movably connected to the lower jaw, the upper jaw having a first side surface, a second side surface, a lower surface, a front surface, and plurality of seat surfaces; and
a replaceable piercing tip mounted on the upper jaw, the piercing tip including:
a first part secured to the upper jaw, the first part including a first planar surface abutting the first side surface; and
a second part secured to the upper jaw and the first part, the second part including:
a planar portion including an inner surface abutting the second side surface, and
a projecting portion including:
an upper surface abutting the lower surface, and
a projecting surface abutting the first planar surface of the first part,
wherein the upper surface covers the entire lower surface of the jaw.

21. The shear of claim 20, further including a plurality of bolts securing the first part and the second part to each other and the jaw.

22. The shear of claim 20, further including a plurality of dowels aligning the piercing tip with the jaw.

23. The shear of claim 20, wherein the projecting portion further includes a second inner surface configured to abut the front surface of the jaw.

24. The shear of claim 23, wherein the second inner surface is perpendicular to the first inner surface of the planar portion and forms an inside corner with the upper surface of the projecting portion, the inside corner receiving a leading edge of the jaw.

25. The shear of claim 23, wherein:
the first part includes a first seat surface,
the second part includes an L-shaped second seat surface formed by the projecting portion and the planar portion, and
the first seat surface and second seat surface together abut the seat surfaces of the jaw on three sides of the jaw.

26. The shear of claim 20, wherein:
the first part includes:
a first pair of seat surfaces; and
a second pair of seat surfaces symmetrically arranged with respect to the first pair of seat surfaces, and
the first part is reversible between a first orientation in which the first pair of seat surfaces are exposed for use as a cutting edge and the second pair of seat surfaces abut seat surfaces of the jaw, and a second orientation in which the second pair of seat surfaces are exposed for use as a cutting edge and the first pair of seat surfaces abut the seat surfaces of the jaw.
